(19) United States
(12) Patent Application Publication
(10) Pub. No.: US 2007/0088714 A1
(43) Pub. Date: Apr. 19, 2007

(54) Methods and apparatuses for collection, processing, and utilization of viewing data

(76) Inventors: Gregory T. Edwards, Roseville, CA (US); Colin V.T. Johnson, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/584,382

(22) Filed: Oct. 19, 2006

Related U.S. Application Data
(60) Provisional application No. 60/728,466, filed on Oct. 19, 2005.

(51) Int. Cl. G06F 17/30

(52) U.S. Cl. 707/10

(57) ABSTRACT

Methods and apparatuses for collection, processing, and utilization of viewing data. An embodiment of a server includes a link with a source of viewing data, the source of viewing data to record viewing data that is related to activities performed by an individual. The server is to receive the recorded viewing data. The server further includes a memory for storing data. The data to be stored includes the recorded viewing data related to the activities performed by the individual. The server also includes a processor to process viewing data.

### RELATED APPLICATIONS

This U.S. Patent application claims priority to provisional application No. 60/728,466, filed Oct. 19, 2005, entitled “METHODS OF COLLECTING, PARSING, ANALYZING, UTILIZING, AUGMENTING VIEWING DATA.”

### TECHNICAL FIELD

The invention relates to viewing data operations. More particularly, the invention relates to techniques and applications for use in association with collection, processing, and utilization of viewing data.

### BACKGROUND

Viewing data may be collected using devices such as eyetracking devices, which operate to track the movement of a person's face and eyes as that person engages in an activity. In particular, eyetracking devices may record viewing data in connection with the use of a computer system. Eyetracking devices may consist of a camera and associated electronic components to produce data representing gaze positions. This data can be used to determine where the individual is looking, which can be described in terms of fixations (a steady gaze for a predetermined period of time) and saccades (movement of the gaze between two points).

Eyetracker data may be combined with data representing graphical or visual images presented to a user to generate viewing data indicating what a person was viewing. The viewing data can be used, for example, to determine whether a viewer has looked at all of the information presented, or whether a person made certain choices in connection with the information presented. The viewing data may be presented in a report, which may include graphical representations of the data.

Viewing data may be collected for the purpose of studying particular presentations, web sites, advertising, or other visual stimuli, and studies are generally conducted for certain intended users of the data. However, in conventional operations the recording and processing of viewing data are closely connected, such as in the operation of single machine. The interconnection of recording and processing of data means that the collector of data also has access to analysis, and to the purposes of the data collection, which creates implications for data security and other issues.

The collection of eyetracking data generally involves recording data regarding the activities of a particular individual or group of individuals who meet certain demographic requirements. The collection of data is generally conducted on the basis of a certain study or purpose. Thus, data collection equipment is unfortunately limited in its use. Further, this means that individuals are generally limited to providing data for a single client, even if the individual would potentially meet the demographic requirements provided by multiple clients.

### BRIEF DESCRIPTION OF THE DRAWINGS

The invention is illustrated by way pf example, and not by way of limitation, in the figures of the accompanying drawings in which like reference numerals refer to similar elements.

FIG. 1 is an illustration of a system for recording and processing of viewing data;

FIG. 2 illustrates an embodiment of the generation of viewing data for multiple clients;

FIG. 3 is an illustration of an embodiment of a system for collection, processing, and utilization of viewing data;

FIG. 4 is an illustration of an embodiment of an eyetracking data server;

FIG. 5 is a flowchart to illustrate an embodiment of the collection, processing, and utilization of viewing data;

FIG. 6 is a flowchart to illustrate the use of viewing data from an individual for multiple clients;

FIG. 7 is a block diagram of one embodiment of an electronic system;

FIG. 8 is a conceptual illustration of one embodiment of an eye interpretation engine that interacts with an eye aware application;

FIG. 9 is a block diagram of a first embodiment of a distributed architecture for supporting eye interpretation functionality;

FIG. 10 is a block diagram of a second embodiment of a distributed architecture for supporting eye interpretation functionality having an aggregator; and

FIG. 11 is a block diagram of one embodiment of an electronic system running multiple applications sharing a single eye interpretation engine.

### DETAILED DESCRIPTION

Techniques for collection, processing, and utilization of viewing data are described.

In the following description, for purposes of explanation, numerous specific details are set forth in order to provide a thorough understanding of the invention. It will be apparent, however, to one skilled in the art that the invention can be practiced without some of these specific details. In other instances, structures and devices are shown in block diagram form in order to avoid obscuring the invention.

For the purposes of the following description that follows:

“Viewing data” means data concerning what a person or persons has viewed. The term may include, but is not limited to data collected regarding the viewing of a computer screen or other computer presentation.

“Eyetracker” means any method, device, system, or technique for measuring and reporting where a person, group of people, or other entity is looking. An eyetracker may provide such measurements in 2, 3, 4, or more dimensions. An eyetracker may be used in the collection of viewing data.

“Eyetracker data” means data returned by an eyetracker. Eyetracker data for a person may include data for one eye, for two eyes, or for a combination of the eyes' data. For example, eyetracker data may include x-axis, y-axis and/or z-axis coordinates, time, pupil diameter, percent of time eyelid is open, object(s) being viewed on a computer screen or in the world or an environment (reported explicitly or implicitly via the coordinate system), distance from eye(s) to the point or object being viewed, extent of peripheral vision, and/or other eye-related data. Viewing data may include eyetracker data.

“Eye Interpretation Engine” or “EIE” means any technique, algorithm embodied in computer-readable instructions, circuit and/or device capable of computing higher-level characteristics and/or behaviors from eyetracking data from one or more people, with or without additional environmental data or supporting context. EIEs may also add data to the eyetracking data such as probable field of peripheral vision for an individual or a group, or related to the object being viewed if it is known, as well as other data that would be a super-set of that returned by an eyetracker. An EIE may be used in the generation of viewing data based on collected eyetracker data.

“Application” means any technique, algorithm embodied in computer-readable instructions, a circuit, and/or a device that receives input signals or data and generates output data or signals.

“Eye-Aware Application” means an application that makes use of eyetracking data.

In an embodiment of the invention, a system is provided for the collection, processing, and utilization of viewing data, including data that is based upon eyetracker operation. In an embodiment of the invention, a system provides for separation of the recording and processing of viewing data.

In an embodiment of the invention, a system includes a server that provides for the processing of viewing data, including the analysis and distribution of such data, and includes a data source that records viewing data for the use of the server. In an embodiment of the invention, the operation of the server and the data source are separated, with the data source being responsible only for the recording. In an embodiment, a data source records viewing data for activities under the direction of a server without requiring any knowledge regarding the purpose of the recorded data. As used herein, “server” means any computer device that is responsible for all or part of the processing of viewing data, or the provision of instructions relating to the collection of viewing data. A server may include multiple computers, including, for example, multiple server units that operate to handle different aspects of data processing.

A data source that is recording viewing data may provide services for multiple different clients. Each client may provide demographic requirements for the individuals who engage in activities for data recording. In such operations, it is possible that one individual may meet the demographic requirements of multiple clients. In an embodiment of the invention, a data source may collect viewing data from an individual for multiple clients. In one example, after the demographics for an individual have been determined, it is possible that the individual meets requirements of both a first client and a second client. In this example, the server may provide instructions for activities to be performed by the individual for both the first client and the second client, with the data source recording the data for all such activities. The data source provides such data to the server, with the server then, for example, separating and processing the data for the service of each of the requesting clients. However, embodiments of the invention are not limited to this particular process, and the structure of activities may vary in different implementations. In an example, a server may break up a data recording session into multiple “mini-studies”, where each such mini-study is focused on the needs of one client but each of which makes use of observations of the same individual. In an embodiment of the invention, an eyetracker server stores viewing data based upon data that is received from multiple sources. In an embodiment, the sources receive directions for implementation of a study from the server. As used herein, a “study” is any effort to collect viewing data for a purpose.

In various embodiments of the invention, the connection of a server and a data recorder will vary. In an embodiment, the server and the data recorder are separate units that communicate in various ways, depending on the particular arrangements. For example, the server and the data recorder may be connected via the Internet or another network. In an embodiment, the server and the data recorder are located in separate physical locations.

In an embodiment of the invention, a system provides viewing data to multiple requesters of the viewing data, who may be referred to as clients or as the owners of the viewing data. In an embodiment, the system includes data for multiple owners, with each owner being able to access only the data to which the owner is entitled. In an embodiment of the invention, a data element may be owned by one owner, multiple owners, or no owners. A set of data owned by a first owner may include or overlap with data owned by a second owner. In an embodiment, an owner may request the collection of certain data, or may become the owner of previously collected data.

In an embodiment of the invention, a system provides for the separation of the collection, processing, and ownership of viewing data. In an embodiment, a device for recording viewing data may record the viewing data from test participants separately from the processing of the data that is recorded.

To achieve meaningful results, a researcher must conduct the following critical steps:

(1) Decide what question to research.

(2) Craft a test scenario that mimics the conditions to be researched.

(3) Determine what variables must be controlled to make sure that the data collected is valid.

(4) Collect the data in a way that controls all the variables.

(5) Analyze the collected data.

(6) Determine what the data means relative to the original research questions.

In an embodiment of the invention, a system is provided to support research for viewing data. In embodiment of the invention, the system allows for the generation of results while separating the collection, processing, and ownership to the data. For example, a source of eyetracking data may record viewing data, with the source potentially including multiple eyetracking devices. The source may be recording data for multiple clients at any time, with the data to be collected at any point being determined in part by the demographics of the individuals who are available for study. In some cases, the same data may be relevant to the needs of more than one client. However, the source of eyetracking data may not be aware of the purposes for which the data is collected, and may have no knowledge of the intended owner or owners of the collected data.

When the eyetracking data has been collected, the data may be correlated to separate the data for the appropriate analysis. For example, the data may include a first portion that is related to activities requested by a first client, and a second portion that is related to activities requested by a second client. After collecting the data, the data may be provided for processing that is separate from the recording of the data, with the processing possibly including analysis of the data. In an example, viewing data that is recorded by a data recorder may be presented to a server or servers (referred to herein as an eyetracker server), with the eyetracker server providing for any processing of the recorded data. The processing of the recorded data may include analysis of the viewing data, or may include the preparation of images that represent the data. In an embodiment, the analysis may be provided by third parties, such as in the form of analysis modules that are provided on the eyetracker server.

In an embodiment of the invention, collected viewing data is stored, such as in a database. The database may be a part of a data server, or may be separate database of any type. An owner of some portion of the viewing data is provided access to the viewing data to which the owner is entitled, but not to any other data. The data that is owner by a first data owner may include or overlap with the data owned by a second data owner. In some cases, the owner of the data may have no knowledge of the sources of the data, and may be unaware of who else may have ownership of the same or overlapping data. In an embodiment, an owner may choose a particular analyzer for the analysis of the data owned by the data owner.

The separation of the collection, processing, and utilization of viewing data may be used to increase the efficiency of data collection, to increase the value of eyetracking equipment usage, to encourage development of analysis technology, and to increase the availability of useful data. The use of data from multiple sources may create a higher likelihood that person meeting study demographic requirements will be located. In an embodiment of the invention, an individual who meets the demographic requirements of more than one study may take part in each such study. In such a case, the separate collector of the data may be unaware of the purposes of the collected data, or that the individual is participating in multiple studies. An embodiment of the invention thus may allow eyetracking equipment to be used more efficiently because the equipment may potentially be used for portions of many studies at the same time. Analysis technology may be supported because processing, including the analysis of data, can be separated from data collection, and may be chosen as desired. Viewing data may also be made more available by the potential separation of the study process to the ultimate ownership of the data, allowing a person to purchase the use of eyetracking data without necessarily commissioning the study.

In an example, a study may include the collection and analysis of viewing data relating to the viewing of computer screens. However, embodiments of the invention are not limited to this example, and may involve the viewing of any phenomena, including, but not limited to, images projected on a screen; real world scenes or displays; shopping aisles and product and advertisement placement in such environment; and other visual stimuli. In this example, the screens may be, for example web pages, but embodiments of the invention are applicable to any computer displays, as well as other types of viewing processes. In this example, the viewing data may include the manner in which each study participant views the computer screen, including what areas of the screen are viewed and which are not viewed. In the generation of viewing data for a study, scripting language and configuration functionality may be utilized to automate operations, including the creation of task launch pages. In an embodiment, the scripting language and configuration tag the data in a manner that allows the conduct of analysis against the variables that the task launch pages have controlled.

In an embodiment of the invention, a script language allows the definition and specification of a study that enables the specific definition of study tasks, stimuli, and questions, and the order in which these would appear to any person who participates in the study. The protocol automatically generates pages that the test participants use to guide them through a study. The protocol delivers the appropriate tasks to the study participants, asks the questions of the participants, collect the answers of the participants, and ensures that each participant has a custom configuration, if that is necessary. In an embodiment, the script may be employed in a markup language similar to XML. In an interface is provided that enables test participants to self-administer a study session without reliance upon the assistance of a test moderator. In an embodiment of the invention, the interface associates of eyetracker data collected with a given task, question, stimulus, or person.

In the conduct of a study, a test moderator may choose a study to run, and may further chooses a particular profile to run. In a given study, there may be many different profiles that have unique characteristics relative to the other profiles. Typical unique characteristics might include versions of stimuli, task order, questions asked, or appropriateness to a given individual who will participate in the study.

A data owner is the person who possesses a license (authorization) to view a given subset of the data collected. A data owner may also be referred to as a client for the collection of viewing data. The collection of viewing data is generally conducted on the behalf of a client. However, in a conventional operation, if the administrator of a viewing data system is required to handle each aspect of data operation, thereby limiting the services that may be provided for each client. For example, if the administration was not readily at hand to do the different steps related to transferring data to the accounts of each owner, the system might sit idle for hours until the administrator returned to kick off the next step in the process.

In an embodiment of the invention, data owners are served more effectively by the separation of the collection, processing, and ownership of viewing data. For example, once data is transferred to an account, it is then processed to create all the necessary configurations of data, and subsequent images and statistics. The entire process generally requires multiple steps for completion. In a conventional system, a researcher needed to go into the dataset to figure out what configurations of the data were most important and most informative. A tremendous amount of effort had to be expended on the part of the researcher to assess the goals and objectives of the trial, and then define the relevant configurations and analyses on the data. In an embodiment, the processing of the data is separated from the collection, allowing a researcher to receive data that is correlated for a particular purpose, thus simplifying operations and allowing automation of many processes.

An embodiment of a process to define a given configuration of viewing data (which may be referred to as a report page) includes the following:

(1) Defining the name of a report page and a description of what the page is meant to depict.

(2) Defining the format of the report page.

(3) Defining the angle of the data that is of interest, which may be referred to as a “slice”. Slices may be tasks, URLs (uniform resource locators), ZOIs (zones of interest), task order, combinations of slices, task feedback input, demographic feedback, or any other aspect of the data. In an embodiment, an application may conduct segmentation on the basis of multiple different slices.

4) Choosing statistics that are desired in relation to the view on the data that one has selected. This may include data images and visualizations, such as “heatmap” of viewing, or statistics. The data may be in relation to an entire page or element of media, or on a small section of that media. The sections may be referred to as “zones of interest”.

Using this described output, a researcher is generally required do analysis of the data to draw conclusions and determine the relevance to the original questions that drove the research in the first place. In an embodiment of the invention, a task launch page configurator may include the following:

(1) Automatic creation of needed task launch pages from the definition of the appropriate scenarios.

(2) Automatic management of the collection process that allows an administrator to be aware at all times of the status of data collection. The configurator may manage and administer user calibrations and the related files without requiring that additional pieces of software be used outside of the interface application. It also dynamically serves these tasks to test participants in a way that best matches their demographic description to the tasks that should be completed by test participants with the relevant demographic description.

(3) Balancing of data collection from multiple sites so that data can be collected simultaneously from numerous locations and eyetracking installations, and coordination of collection such that the collected data may be seamlessly available for analysis.

(4) Notification of test administrators when the necessary data is collected, and notification regarding any required adjustments to recruiting schedules based on the success or lack of success in obtaining needed data.

In an embodiment of the invention, automated data processing instructions may include:

(1) Automatically assigning collected data to any appropriate sub-accounts within the analysis application.

(2) Pre-processing each segmentation of the data that is necessary to perform logical analysis.

Once the content of the study is defined, such as through a task wizard or by the work of a trained professional, a task launch page configurator takes all the items deemed necessary in the test design and creates launch pages for the participant to use in the test. Launch pages are one form of instructions that may be provided by a server to describe activities for a test participant. However, embodiments of the invention are not limited to these types of instructions, and may include any form of instructions for a test participant. Launch pages may be served to or viewed by a test participant using a web browser or similar computer application, but embodiments of the invention are not limited to the use of any particular display application or mechanism.

In an embodiment of the invention, the task launch page configurator may uses natural language, rather than relying on a series of XML-like tags. In addition to controlling the presentation of tasks, stimuli, and questions, the configurator also may manage additional information required when running an eyetracking study. Using this information the task launch page generator may allow a researcher using the system to control all aspects of the tasks, questions, and the order in which they are presented for any study that the researcher designs. In addition, the system may address creating and updating of the task script through natural language. In an embodiment, a method may allow a researcher to input in plain language the parameters needed to administer a test, and automatically generate the needed test interface pages based on such parameters.

Items that the script allows a test preparer to indicate include, the name of the test, a description of the test, the start date and end date for the test, the wording for all tasks, the owner of the task (provided because certain test data may be automatically given to different account names on the basis of this indication—data may be assigned to an owner before testing or may be assigned later), the minimum and maximum number of people needed to complete the task, the wording of the task, the questions that are asked around the task, the starting location of the task, the characteristics of the data to be collected that are of particular interest and which data should be pre-processed by the analysis application. In addition, the script will instruct the system to do particular kinds of analysis on the data as deemed appropriate. In some instances a particular task will not owned by a particular owner, such as when the task is of general operation. However, the specific application of the task to certain web pages may be assigned to an owner.

In an embodiment of the invention, configuring the testing launch pages in this way may assist in operation because the script provides a series of instructions that work in the way that people think. In this manner, rather than a researcher being required to change the way that the researcher thinks to meet the needs of the machine when configuring task launch pages, instead the system is intended to conforms itself to the way that the researcher wants to think about the test design. This process further allows the task wizard to output a test design in plain English that a researcher can review without having to understand any type of programming code. It also makes it easier for someone to craft a script without the use or assistance of the task wizard.

In an embodiment of the invention, a method includes taking the parameters indicated by the test script and calculating various factors that need to be accounted for in the test, such as participant and task counter balancing, recruiting requirements, data segmentations, demographic segmentations, segmentations keyed off of the participants' responses, segmentations keyed off of participants' behaviors, and the like.

In an embodiment of the invention, if the order of the tasks and the participants for a study is not defined by a researcher, the system will establish these automatically. In an embodiment, when the test instructions are loaded into the system, the method will automatically calculate an optimal counterbalancing of tasks and participants for each profile that is created. One way to achieve this distribution is present the order of each of the tasks in an optimal Latin square configuration where every task will get as equal exposure to each slot in the test design so that it gets equal exposure to position within test as well as in relationship to other tasks. Alternatively, the tasks may have a different optimal ordering protocol that they should follow based on the particularities of the study. The system will be able to accommodate different options.

In an embodiment of the invention, a system will also determine from the test design how many people of what demographic descriptions are needed to fulfill a given data request. The system will then specify a recruiting request that will be sent out to whatever recruiting utility is most convenient. The details of bringing people to the eyetracking terminals can be administered through the recruiting engine or manually by someone acting as a recruiting coordinator.

In an embodiment, as the data is collected from one or more different eyetracking terminals, a system will monitor the progress of data collection and compare that progress to what remains to be done as specified in the task launch page configurator. For example, at any given time, an administrator would be able to see how many more people of what description in what markets are still needed to complete the data collection of a particular task or test.

In an embodiment of the invention, a task launch page configurator dynamically balances which tasks are served based on the description of the participant, rather than according to an arbitrary ordering of tasks in a given study. The dynamic task serving engine will place each task into a central pool of tasks to be completed. Then, as participants log into the system to participate, the system will determine the participant's demographic description and provide tasks to that person that need to be completed by people of that person's demographic description. The tasks will be served in the order of their priority as determined by a rank that accompanies each task. The tasks may include tasks for multiple clients. The ranking system for tasks presented to a participant may be driven by external factors, such as whether or not a particular client has requested a rush order and thus requires priority to task completion, where the task is to be used in an unpaid case study and thus is of lower priority, or other such issues that might affect ranking. This pool of tasks will be accessible from multiple eyetracking terminals in multiple markets and will allow for real time data collection and presentation. For example, twenty eyetrackers could be used around the world and simultaneously collect data on a single task. By collecting data simultaneously in this way, results may be available quickly if people of the proper demographic description are available for trials

The data processing instructions may also inform an application regarding what to do with the data once it has been collected. A device on the test participant's computer may prepare the compiled data file that recorded what the person did during the session, and then automatically loads it to a processing system. Once the data file arrives in the processing system, data processing instructions may tell an application what needs to be done to that data in order to fulfill its requirements as specified in the test script/task launch page configurator.

In some cases, the data that is collected may need to be copied to one or more different accounts, the data of each account thus overlapping. Further, the data may need to be processed in a way to create the different segmentations of the data that a researcher might require. In an embodiment, an application may be instructed to preprocess all the different views on a dataset that will be needed. Preprocessing may be handled in multiple ways. One manner in which preprocessing may be done is by creating data and images for each URL visited, page opened, or stimuli viewed, and for all images viewed within a task (or, an image for every element viewed in the client's dataset). In one embodiment, such preprocessing may be ordered based on an average sequence of viewing across the range of individuals who participated in the task or study. In another embodiment, preprocessing may include the generation of only the initial pages, stimuli, or other elements that would be first viewed after a person started following the set of task instructions.

In an embodiment of invention, when an application detects in a dataset a parameter that was not identified by the researcher but which can be a basis for comparison, the application pre-processes a definition of the data slice for that parameter and does analysis to see if there is any statistically significant difference between the two or more elements being compared. In this manner, an application may provide valuable analysis that was not anticipated.

In an embodiment of the invention, when all the processing of data is complete and in most cases (though this is not required) after the reports are also created, an application will notify the appropriate person through an appropriate method that all the processing is complete and the data and analysis is available for review. In an embodiment, the appropriate person may be an administrator of the system or an account manager. In an expanded embodiment that contains further self-serve abilities, the appropriate person might be the client. In an embodiment, notification method might be E-mail, but many different methods may be utilized for notification.

In an embodiment, an application may generate many different statistics regarding viewing data. A statistics validation utility may augment the informative power of the statistics by putting each statistic through an automated testing protocol to determine all the characteristics on the viewing related data, such as the variance, distribution, validity, and other values. Once an application tests which statistics are valid, that application may provide a modified presentation of the statistics to test the numbers and recommend the most valid ones. In an embodiment, a utility may examine the nature of the data making up a statistic and would then put it through the different tests that are used in statistics to determine such things as levels of significance, percentages of certainty and margins of error.

A plain language (such as plain English) script may be used in order to enable, through a sequence of computations, an eyetracking study to be presented to individuals, their data collected, processed, and then presented as a report. In an embodiment, a system automates most tasks necessary for a study, enabling a requestor to write instructions for a study, and with the series of instructions then being carried through the data collection phase, the processing phase, and initial reporting stage so that a report can be produced automatically.

In an embodiment of the invention, a script is specified using, for example, a text-parser. A text-parser may include JavaCC for processing a text script, but the use of various different parsers is well known in the field. The text parser may operate to:

(1) Specify a name for the task for reference usage. (If none is provided then a default name could be generated, such as “task 1”.)

(2) Specify the question(s) to ask before a task.

(3) Define a task to be performed.

(4) Identify a URL to be clicked on to begin the task.

(5) Specify question(s) to ask after the task is completed.

Questions may be re-used by, for example, assigning a question_reference_id, thereby enabling the questions to be referred to by their reference_id whenever they are needed again. This is done by adding an optional “<question_reference_name>=” before the question's name. Other methods may also be used to designate such questions.

In embodiments of the invention, there are many different options for how questions and tasks may be linked. In one example, a task may contain the text of the task, along with the launch URL, and other information, together with a list of questions that have a pointer or reference ID for the task so that they can be linked to the task.

Multiple tasks can be specified in a script, and then a “profile” can provide the ordering of those tasks by listing each task's reference_id in the desired order. Multiple profiles can be specified in order to provide counter-balanced task orderings, as well as to provide different combinations of tasks. For example, one profile could include tasks 1, 2, and 3, and another profile could include tasks 1, 4, and 5. A profile could be represented as a sequence of tasks, which themselves specify both the task and the questions linked to the task.

The specifications for the pre/post-Questions, task, and starting URL may be saved in a database, or any other persistence mechanism, and then displayed to the participants through some medium, such as a web browser displaying this on a web page. This process enables a task to be executed, and, when used in conjunction with a recorder that records information relating time-stamped eyetracking data to applications on the screen, browser pages, scrolling information, mouse and keyboard events, and screen images that show what was on the screen at any given moment, this enables tasks to be executed by a study participant and recorded by the recording software.

Tasks can also have associated with them the number of people who are expected to be needed to execute the task. For example, a Min/Max range can be provided to ensure the minimum number of participants, while allowing some overage to account for possible loss of data or poor data quality from the eyetracking equipment and at the same time specifying a cap in the number of participants. With the min/max number, it is possible to check in on the progress of a study, determining how many people have completed the task so far and how many are remaining. This may be done by incrementing a counter each time that a data session is uploaded that contains the relevant task.

One or more owners may be specified for tasks. When one study is being run that can satisfy the requirements of multiple clients but where not all clients are authorized to see all of the data collected, access can be granted to view a task's data by making a client an owner of the task. One or more clients can own the same task, or, in other words, can have access to view the data. In one example, this may be implemented by maintaining an access control list (ACL) for each task, and adding the owner to the list of that task, against which authorization to view or interact with the data within the task will be checked. Embodiments of the invention are not limited to use of an access control list, and numerous other methods of limited access to data may also be used in this context. In addition, an owner may be provided access only to the time when a specific URL was visible on the screen. This is done by adding to the access control list authorization to view only the times when the particular URL is active during the task.

In addition to specifying the tasks, the order of tasks, how many people are needed for the tasks, and the ownership of tasks, it is possible to start specifying the final report which will be automatically generated once the data has been collected and the datafiles uploaded. Specifically, information about study demographics can be entered, as well as a write-up of a summary of what the study should uncover. The demographic information entered can also be used in the recruitment and fulfillment process to make sure that the correct people are recruited. In one possible example, a particular set of required demographics be the list:

(1) Regular Internet access by participant,

(2) Age of participant: 30-40 years of age

(3) Professionals

(4) Commuters

In an embodiment, the demographics of an individual may compared to such a list, or to multiple such lists, to determine the task or tasks for which the individual would qualify.

“Keypages” can be specified for analysis by adding the keyword “keypages: <N>” (where “<N>” is replaced by a number) in the task specification in the script. Doing this will generate a report which has all of the pages that are visited by N or more people. In this way, a user can quickly get an idea of what happened in general by seeing which pages were hit by “most” (or at least N) people. In an embodiment, these pages may be ordered based on the average viewing sequence of all people who looked at each page.

In an embodiment, reporting and analysis may begin by describing what one would like to compare. For example, it is often beneficial to compare the data from groups of people visiting a URL (a web page) over time, or across different studies. This can be specified by indicating that one would like to compare a URL to other URLs from another study. If the user wanted to compare a URL (e.g. http://www.example.com/) to all other instances of that URL in previous studies, this could be specified by entering (using “[study N]” to indicate all studies prior to the current study):
compare:
   http://www.example.com/
   [study N] http://www.example.com/

In a further example, if a user wanted to compare a URL to other URLs from previous studies that had different URL designations (e.g., for comparing different versions of a homepage before it was finally launched and tested in the current study), this could be specified by identifying the study and the URL from previous studies:
compare:
   http://www.example.com/
   [study 2] http://www.example.com/proto4.htm
   [study 1] http://www.example.com/proto1.htm

This specification could place the data and/or images for each page/URL onto a single page, or into an area for further analysis and formatting. One example of how to do this would be to put data/images for each entry into a table so that they could all be viewed side-by-side.

Where the different steps required to generate a given result are sufficiently specific to be unusual, an application may issue a copy of the instructions so that the overall process can be repeated, to the extent that it is not standardized within the context of the application's normal operation. This is then coupled with the task launch page instructions and the report generation instructions to create a full set of commands for a system that can be reused by researchers that want to repeat some or all of the operations of the trial. In another example, variables or place-holders may be introduced into the specification of a task or question definition, which then may be used to specify a template script that then could be re-used to satisfy tests that are similar in nature.

In one embodiment of the invention, tailored analysis modules (TAMs) are domain-specific templates that automate data processing and analysis. In one example, a TAM toolbox may be created, and a number of basic TAMs may be established for subscribers to use. A system may also enable subscribers to develop TAMs of their own, or to license use of TAMs created by a third party. A TAM allows a subscriber who has developed a domain and analysis expertise to encapsulate the subscriber's approach in a “plug-in” module. This module will allow the subscriber to efficiently repeat the automated analysis. Subscribers will also be able to share these modules with other subscribers. For those who have a profit motive, like professional services firms, TAMs allow the organization to invest in developing proprietary analysis methodologies that they can then license to other subscribers. This licensing of intellectual capital may appeal to professional services firms, who might otherwise lose consulting business reselling eyetracking products to existing clients. The TAM capability may allows such firms to replace relatively low margin revenue streams like consulting with potentially higher margin revenue streams of licensing.

In an embodiment, the analysis protocol provided by a TAM may be concealed from the person who is doing data collection. The data collector may have no knowledge of the data analysis. The fact that the analysis protocol can be concealed from the person doing the data collection, may, for example, allow a party to commission data collection for conduct by an external party whose only responsibility is to collect data without analysis. By hiding the analysis that is conducted on the data collected, a party may be able to expand operations and have a larger base of data from which to generate conclusions. A researcher thus could outsource data collection without compromising the security of what is being done with the data.

In an embodiment, a system may include a marketplace functionality to allow subscribers who do not have an eyetracker to connect with other subscribers who do and who are willing to collect data on a contract or licensed basis. Effective content and design analytics requires data to analyze, and this functionality may allow subscribers who only want to use the data, like marketers and designers, easy access to large amounts of data. Rather than incurring the overhead expense of collecting large amounts of data directly, this approach may be used to eliminate waste in the supply chain and puts the forces of a competitive marketplace to work in favor of the data consumer. Subscribers who prefer to collect data (the data supplier) also are also provided with a means of monetizing their hardware investment.

In an embodiment, a buyer of data might be a marketer. In one possible example, the buyer might want to know how people who come to a homepage look at that data. In conventional systems, the marketer would either need to find a report that someone has already compiled on this question, or the marketer would be required to commission the collection of data. In most cases the scope of the challenge is so great that it is outside the scope of a single person or entity to collect and market. With a data marketplace, the marketer can instead post a call to the marketplace and request bids from different parties to collect the data on their behalf. Because there is a competitive market where multiple potential collectors of the data can bid, the overall price to have the data collected may drop.

In another embodiment, if there are numerous parties who collect data, and who upload it into an eyetracking system database, that data may then become available to license. The marketplace functionality would allow the marketer to include parameters such as the type of people who view the specified page, the time period in which they may view the page, as well as any other variety of factors, such as like whether or not they liked it, or read only certain portions of the page, or selected only certain items on the page, or any other parameter that is of interest.

In an embodiment, a marketplace would provide those who possess eyetrackers a vehicle to allow them to focus on recruiting people to be test participants and to collect data that either the data collection specialists specify, or have to collect data on studies of general interest that others may have an interest in.

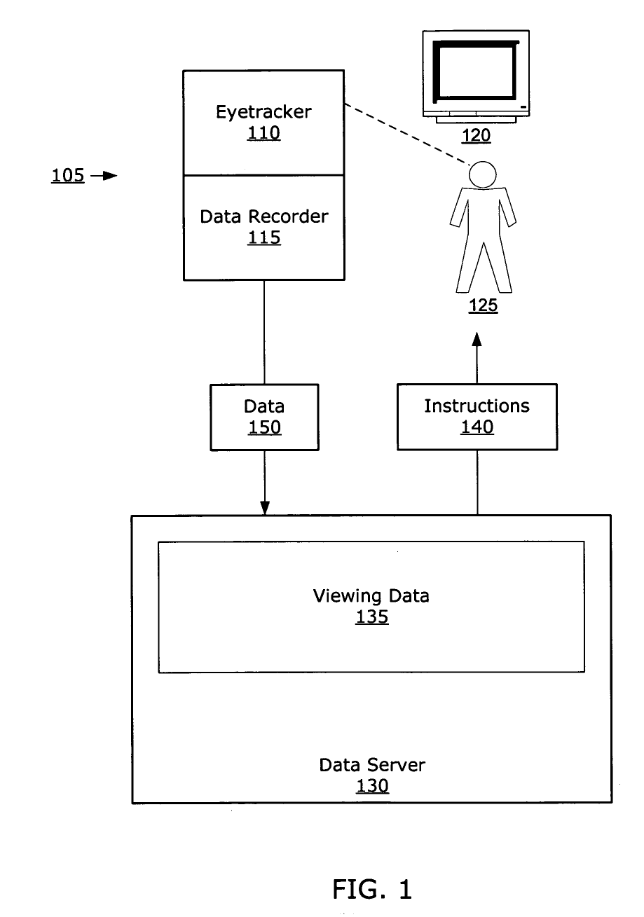

FIG. 1 is an illustration of a system for recording and processing of viewing data. In this illustration, a data source 105 includes an eyetracker to generate viewing data that is recorded by a data recorder 115. In one example, the eyetracker may generate data regarding the viewing by an individual 125 of a computer screen 120. However, embodiments of the invention are not limited to this, and may include the viewing of any type of phenomena.

In an embodiment of the invention, a data server 130 is provided to process viewing data 135. The viewing data may include data 150 that is received from the data source 105. In an embodiment of the invention, the data server may further provide instructions 140 regarding what is viewed by the individual 125, thereby directing what activities of the individual will be recorded. In an embodiment of the invention, the instructions 140 are automatically generated based on requests received.

In an embodiment of the invention, the data source 105 operates separately from the data server. In an embodiment, the data source 105 and the data server may exist in separate physical locations. In an embodiment, the data source may not be aware of the purpose of the activities for recording or the identity of the client or clients who are served.

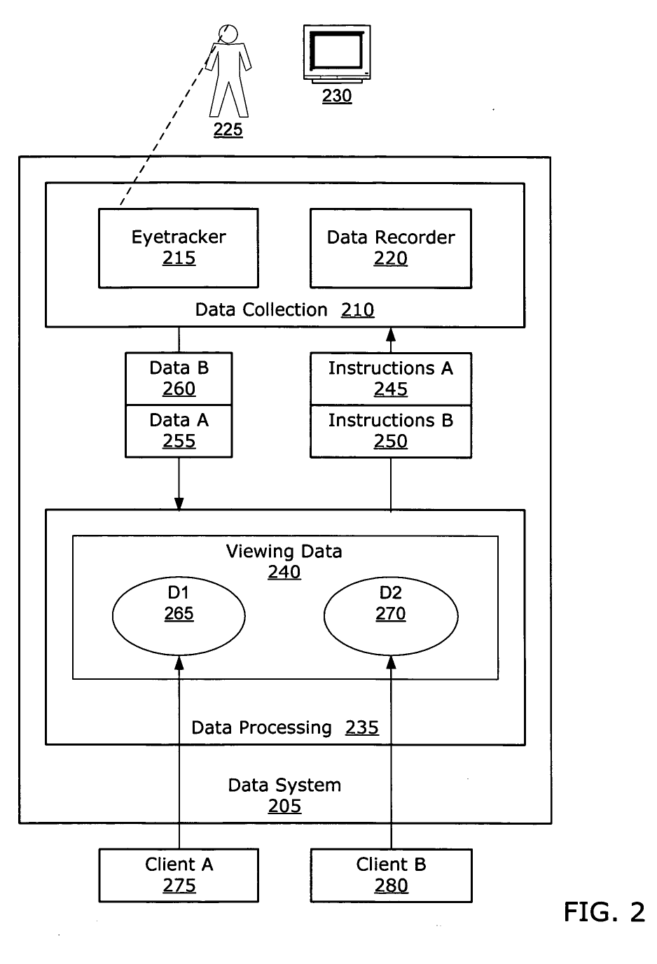

FIG. 2 illustrates an embodiment of the generation of viewing data for multiple clients. In an embodiment of the invention, a data system 205 includes a data collection unit 210 and a data processing unit 235. The data collection unit 210 includes an eyetracker 215 and a data recorder 220. In an embodiment, the eyetracker may collect viewing data for a particular individual 225, such as in the viewing of a computer display 230. In an embodiment, the individual 225 may meet the requirements of tasks to be performed for a first client A 275 and a second client B 280.

In an embodiment, the data processing unit 235 provides instructions A 245 related to tasks for client A 275 and instructions B 250 related to tasks for client B. Upon the performance of the tasks by the individual 225, the eyetracker 215 generates viewing data recorded by data recorder 220. The data collection unit 210 then provides the data processing unit 235 with viewing data A 255 related to the tasks from instructions A and viewing data B related to the tasks from instructions B. While the data is shown separately, the data may be combined or mixed, the data to be correlated by the data processing unit 235. After any necessary processing by the data processing unit 235, viewing data 240 on the data analysis unit 235 includes a first set of viewing data D1 allocated to client A 275 and a second set of viewing data D2 270 allocated to client B 280.

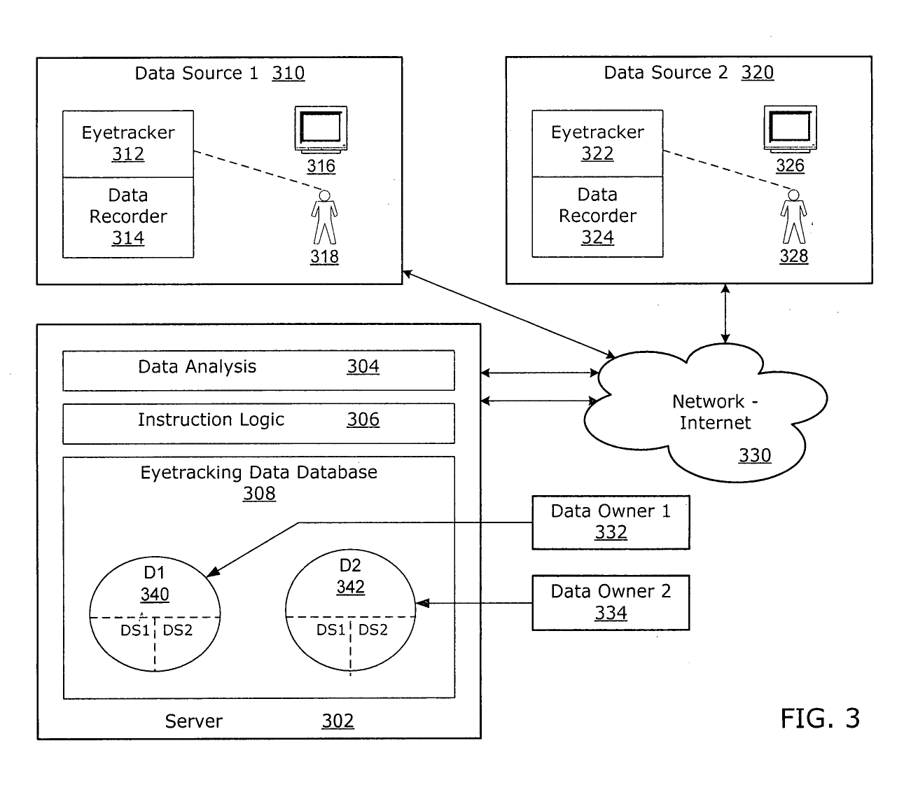

FIG. 3 is an illustration of an embodiment of a system for collection, processing, and utilization of viewing data. In this illustration, a server 302 receives viewing data from multiple different sources, shown as data source 1 310 and data source 2 320. Data source 1 310 may include an eyetracker 312 and a data recorder 314 for the collection of data, such as the collection of viewing data from an individual 318 viewing a computer screen 316. Data source 2 320 may similarly include an eyetracker 322 and a data recorder 324 for the collection of data, such as the collection of viewing data from an individual 328 viewing a computer screen 326. The data sources may be connected with the server in various different ways, including being connected via a network or the Internet 330.

The collected viewing data may be provided to the server for processing. The viewing data 308 may be contained in a database or other storage format. While the data is shown in a database on the server 302, the data may be stored remotely from the server. The server 302 may include a section for data analysis to analysis received viewing data, and a section for instruction logic 306 to provide instructions to the data sources regarding the tasks to be recorded. The data 308 then may be made available to multiple different data owners, shown as data owner 1 332 and data owner 2 334. In an embodiment, each data owner is only allowed to access the data owned by such owner. In an embodiment of invention, the data collected from an individual may used to satisfy the requirements of multiple data owners. Further, multiple data sources may be used to satisfy the requirements of a single data owner. In this example, data owner 1 332 owns a first set of data D1 340, which includes data collected from individual 318 by data source 1 310 and data collected from individual 328 by data source 2 320. Further, data owner 2 334 owns a second set of data D2 342, which includes data collected from individual 318 by data source 1 310 and data collected from individual 328 by data source 2 320. Thus, data collected from individual 318 is used to serve both data owners, as was data collected from individual 328. In addition, multiple data sources are used to serve data owner 1 332, as well as to server data owner 2 334.

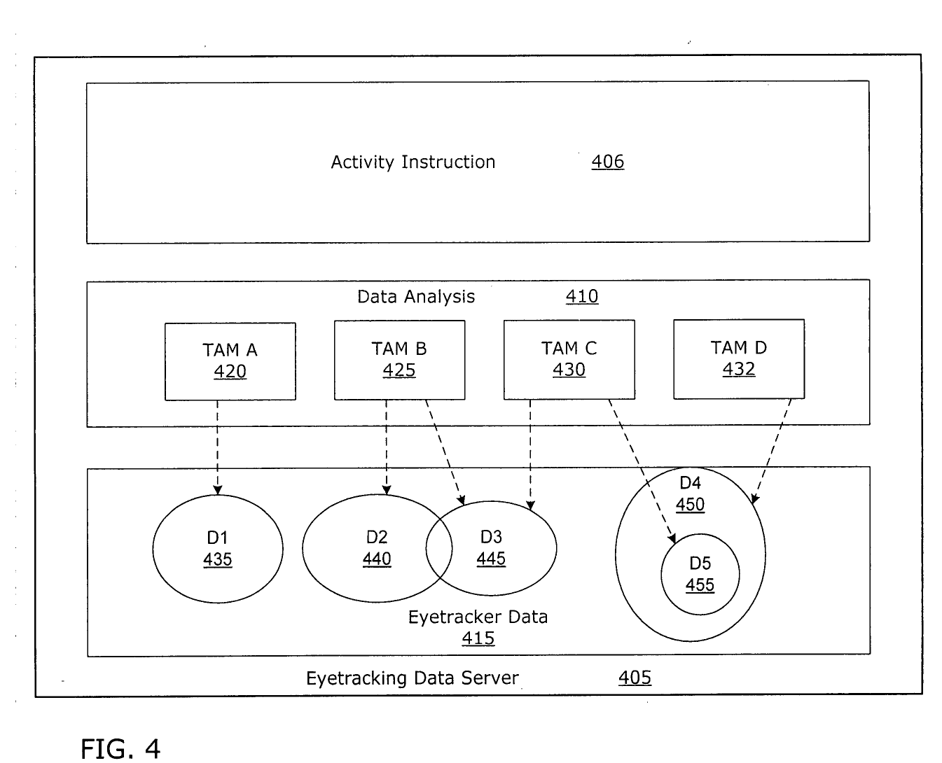

FIG. 4 is an illustration of an embodiment of an eyetracking data server. In an embodiment, an eyetracking data server 405 includes an activity instruction subsection 406 for the generation of instructions for tasks to be performed for viewing data collection. The server 406 further includes a data analysis subsection 410. The data analysis subsection 410 may include, for example, a processor and instructions for providing analysis. The server 405 may further include a database of eyetracker data 415. The data may be received from various different data sources, with each set of data resulting from one or more of the data sources, depending on which test participants are available and how such participants match various study requirements. In this example, the data might include a number of data sets, including a first data set D1 435, a second data set D1 440, a third data set D3 445, a fourth data set D4 450, and a fifth data set D5 455. Each data set might be available to one or more data owners, with each data owner having access only to the data set or sets to which the owner is entitled. The data sets may overlap in various ways, such as in this case D1 440 and D3 445 overlapping in part, such as if a first owner requests certain study demographics that overlap with study demographics desired by a second owner, and D5 455 being a subset of D4 450, such as if a first owner only wants a limited set of data while a second owner wants a more inclusive set of data.

In an embodiment, the data analysis subsection 410 may include various analysis modules for the analysis of data, which may be referred to as TAMs (tailored analysis modules). In one example, multiple TAMs are available for use, including TAM A 420, TAM B 425, TAM C 430, and TAM D 432. The TAMs may be derived from various sources, such as from the operator of the server, from the data owner, or from a third party source. The server, a data owner, or other agent may choose the use of a particular TAM to analyze any particular set of data, thereby providing a variety of options for analysis. In this particular example, TAM A 420 may be used to analyze D1 435, while TAM B 425 may be used to analyze D2 440. However, D3 445 may be owned by multiple owners, and a first owner may request analysis by TAM B 425 and a second owner may request analysis by TAM C 430. Further, TAM C 430 may be used to analyze D5 465, while TAM D 432 is used to analyze D4 450.

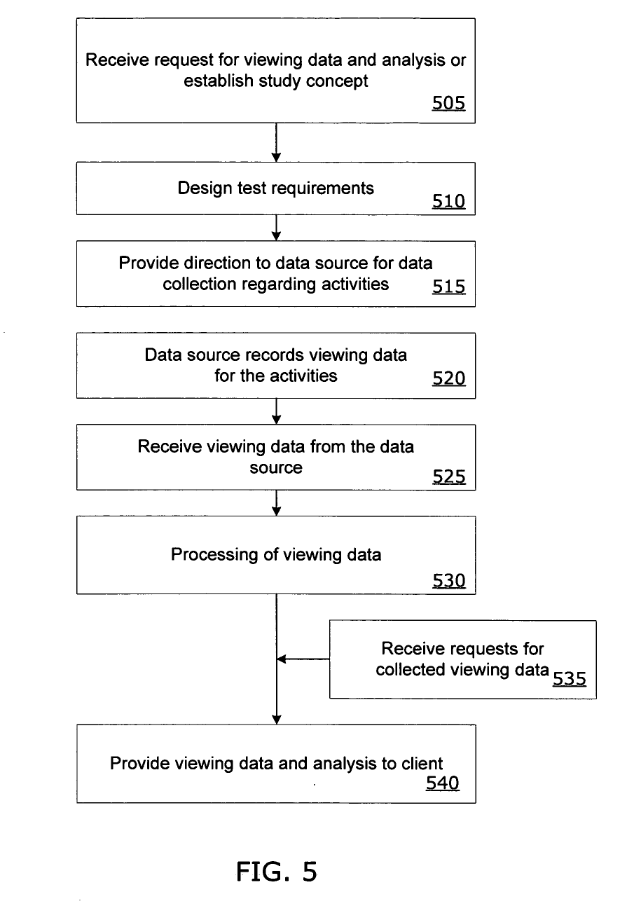

FIG. 5 is a flowchart to illustrate an embodiment of the collection, processing, and utilization of viewing data. In this illustration, a study of viewing may be derived either from a received request for viewing data and analysis or establishment of study concepts without a particular request 505. The study requirements are designed 510, which may include the automatic generation of study questions and procedures. Based on the study requirements, directions are provided to a data source to provide for the collection of the needed data 515.

Upon determining that a participant meets requirements, the data source then records the viewing data for the required activities 520, and the viewing data then is received from the data source 525. Processing of the viewing data then may be provided 530, which may include the used of one or more analyzers to produce statistics, graphical representations of the data, and other report features. In an embodiment, the processing is thus provided separately from the collection of the viewing data. If the data is not already owned exclusively by an owner or owners, requests for the collected data may be received 535. The collected viewing data and analysis then may be provided to a client, with access to the data being limited to the client.

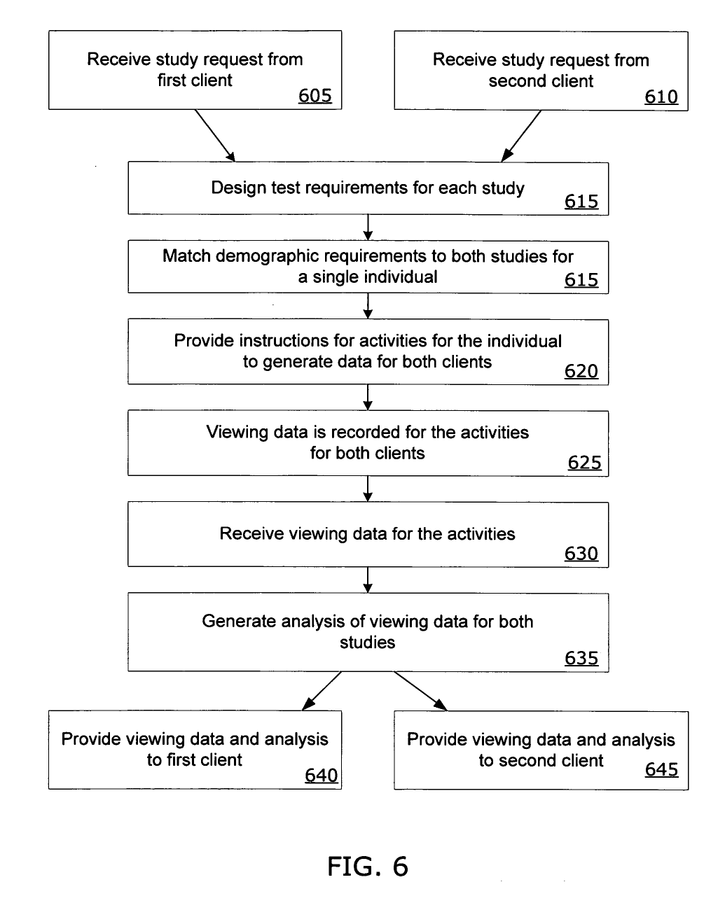

FIG. 6 is a flowchart to illustrate the use of viewing data from an individual for multiple clients. In this illustration, study requests may be received from both a first client 605 and a second client 610. Test requirements are designed for each such study 615. In an instance, demographic requirements may be matched to both studies for a single individual 615,

Instructions are provided for activities for the individual to generate data for both clients 620, and viewing data is recorded for the activities for both clients 625. The viewing data is then received 630, and is processed for both studies. Viewing data and analysis then may be provided to both the first client 640 and the second client 645, with such viewing data and analysis being based in part on the activities performed by the single individual.

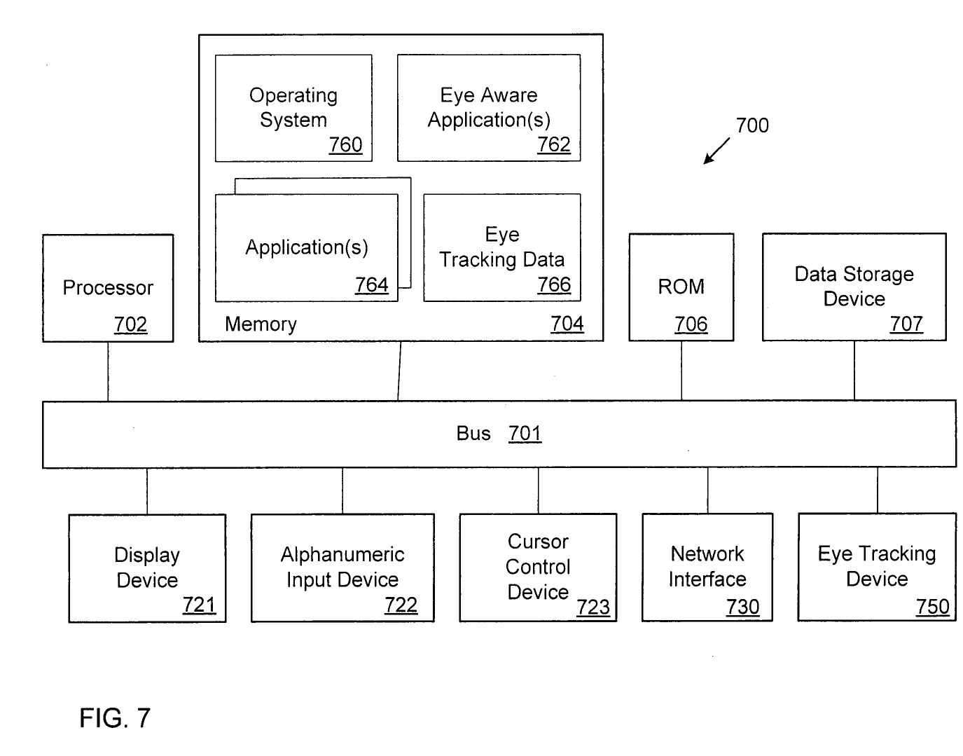

FIG. 7 is a block diagram of one embodiment of an electronic system. The electronic system illustrated in FIG. 7 is intended to represent a range of electronic systems, for example, computer systems, network access devices, personal digital assistants (PDAs), etc. Alternative electronic systems can include more, fewer and/or different components.

The electronic system 700 may include a server or, with the addition of eyetracking capability, may include an eyetracking system. For an eyetracking system, the electronic system 700 may include an eyetracking device; however, the eyetracking device is not required to be part of the same electronic system that processes the eyetracking data. That is, the eyetracking device may be remote with respect to electronic system 700. As another example, of an alternate embodiment with respect to FIG. 7, electronic system 700 may include an eyetracking device, but eyetracking application, an eye interpretation engine or other device or application that makes use of eyetracking data from the eyetracking device may be remote with respect to electronic system 700.

Electronic system 700 includes bus 701 or other communication device to communicate information, and processor 702 coupled to bus 701 to process information. While electronic system 700 is illustrated with a single processor, electronic system 700 can include multiple processors and/or co-processors. Electronic system 700 further includes random access memory (RAM) or other dynamic storage device 704 (referred to as memory), coupled to bus 701 to store information and instructions to be executed by processor 702. Memory 704 also can be used to store temporary variables or other intermediate information during execution of instructions by processor 702. If the electronic system 700 represents a server, the memory 704 may include one or more analysis modules for the analysis of viewing data.

Electronic system 700 also includes read only memory (ROM) and/or other static storage device 706 coupled to bus 701 to store static information and instructions for processor 702. Data storage device 707 is coupled to bus 101 to store information and instructions. Data storage device 707 such as a magnetic disk or optical disc and corresponding drive can be coupled to electronic system 700. If the electronic system 700 represents a server, the server may include a database of viewing data received from various sources.

Memory 704 may includes eye aware application(s) 762 that operate on eyetracking data 766 to generate output representative of viewing data. Additional eyetracking data (not shown in FIG. 7) can be stored on storage device 707 or accessed via network interface 730.

Memory 704 contains operating system 760, which directs operations of system 700. In one embodiment, operating system 760 is the highest layer of control of system 700. Applications 764 are lower layers of system control in that they direct operation within the allowable context of higher system layers. Application(s) 764 may contain user programs (e.g., word processor(s), electronic mail (e-mail) programs).

Electronic system 700 can also be coupled via bus 701 to display device 721, such as a cathode ray tube (CRT) or liquid crystal display (LCD), to display information to a computer user. Alphanumeric input device 722, including alphanumeric and other keys, is typically coupled to bus 701 to communicate information and command selections to processor 702. Another type of user input device is cursor control 723, such as a mouse, a trackball, or cursor direction keys to communicate direction information and command selections to processor 702 and to control cursor movement on display 721. Electronic system 700 further includes network interface 730 to provide access to a network, such as a local area network or the Internet.

Eyetracking device 750 is coupled to bus 701 and generates eyetracking data 766 that can be stored in memory 704 and/or storage device 707. Eyetracking device 750 can be any type of eyetracking device known in the art. For example, eyetracking device 750 can track eye movement via optical, electrical, magnetic and/or other techniques.

Instructions are provided to memory from a storage device, such as magnetic disk, a read-only memory (ROM) integrated circuit, CD-ROM, DVD, via a remote connection (e.g., over a network via network interface 730) that is either wired or wireless providing access to one or more electronically-accessible media, etc. In alternative embodiments, hard-wired circuitry can be used in place of or in combination with software instructions. Thus, execution of sequences of instructions is not limited to any specific combination of hardware circuitry and software instructions.

An electronically-accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

In one embodiment, eyetracking device 750 generates raw data representing eye position and movement. In one embodiment, the raw data is transferred via bus 701 to memory 704 and stored as eyetracking data 166. In an alternate embodiment, eyetracking data 766 includes higher-order interpretations based on underlying raw eyetracking data. Processor 702 executes eye aware application(s) 762 that are responsive to eyetracking data 766.

At the lowest level, eyetracking data is interpreted to identify elementary features. Eyetracking data can be, for example, two-dimensional (x,y) eye gaze positions, three-dimensional (x,y,z) gaze positions, sample time (t), pupil diameter (d), (optionally) the object being viewed (which can be a computer screen, a face, or any object in the world), whether the eye is open or closed, and/or other related information such as biofeedback (e.g., sweat, temperature, heart rate, breathing rate) information. Gaze information can include position, duration, latency and/or other information related to a particular gaze. Elementary features that are determined from the eyetracking data can be, for example, fixations (position, time and/or duration), saccades (magnitude, direction and/or velocity), smoother pursuit motion (path taken by eye, velocity), blinks (duration).

In one embodiment, a fixation is defined as a statistically significant clustering of raw eyetracker data within some space-time interval. A fixation may be identified by analyzing the raw eyetracker data stream to determine if most of the eye positions during a predetermined minimum fixation time interval are within a predetermined minimum fixation space interval. For example, the raw eyetracker data stream can be analyzed to determine whether at least 80% of the eye positions during a 100 ms time interval are within a 0.25 degree space interval. Other values can also be used and other techniques can be used to identify a fixation. Many techniques are known in the art and other techniques for identifying fixations can be used.

A saccade can be defined as the displacement and direction between two fixations. Other elementary features, for example, blinks, smooth pursuit motion and the angel of eye rotation within the head can also be determined from the raw eyetracker data stream.

The elementary features can then be interpreted to determine eye movement patterns. Eye movement patterns can include, for example, revisits, significant fixations, vertical saccades, horizontal saccades, short saccade runs, etc. In one embodiment, an eye movement pattern is a collection of elementary features that satisfies a set of criteria associated with a predetermined eye movement pattern template. In one embodiment, elementary feature data is analyzed after each saccade to determine whether a predefined eye movement pattern exists.

The eyetracker described herein may be associated with, or included in, any type of device for which eyetracking data may be useful. For example, in addition to computer systems with monitors or other display devices, the eyetracker may be in an automobile, a kiosk, a personal digital assistant (PDA), a toy, a game device, a billboard, a telephone, a cellular phone, a television or other monitor not coupled with a computer system, a refrigerator or other appliance, a set-top box, training equipment or educational device, such as books, or other devices providing visual information, glasses, a video conferencing system, mounted on a wall or in any space, etc.

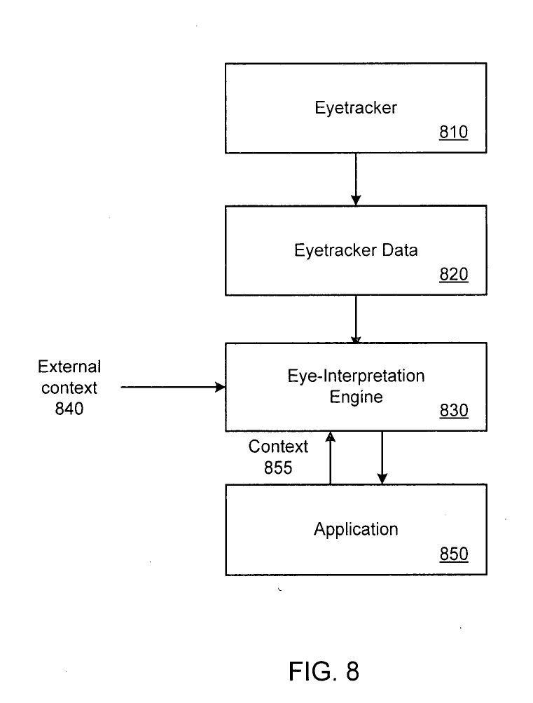

FIG. 8 is a conceptual illustration of one embodiment of an eye interpretation engine that interacts with an eye aware application. In the example of FIG. 8, eyetracker 810 monitors one or more users of a device to provide eyetracker data 820 to eye interpretation engine (EIE) 830. In one embodiment, EIE 830 provides eyetracker data and/or multi-level (or higher-level) eyetracker data interpretations to an application 850.

In one embodiment, application 850 may provide context data 855 to EIE 830. Context data may include, for example, information related to what is displayed by application 850, visual state, application state, operating system state, environmental state and/or conditions, human state (e.g., biometric data), or other information related to a user interaction (current or past) with application 850. EIE 830 may also receive external context information 840 from a source external to application 830, for example a Web server or other source of information for a user of application 850 and/or eyetracker 810 or from another device directly or indirectly connected to the system (not included in FIG. 8).

The interaction of the components of FIG. 8 may be used to provide one embodiment of an eye-aware application that provides a better user experience than a non-eye-aware application. For example, as described in greater detail below, by providing intelligence to an application, the application can provide a customized experience to a user based on eyetracking data gathered from the user.

Discussed above is the general interaction and high-level architecture of a system or network for supporting eye interpretation functionality. The examples that follow provide various configurations for supporting eye interpretation functionality. Other configurations not listed herein can also be used.

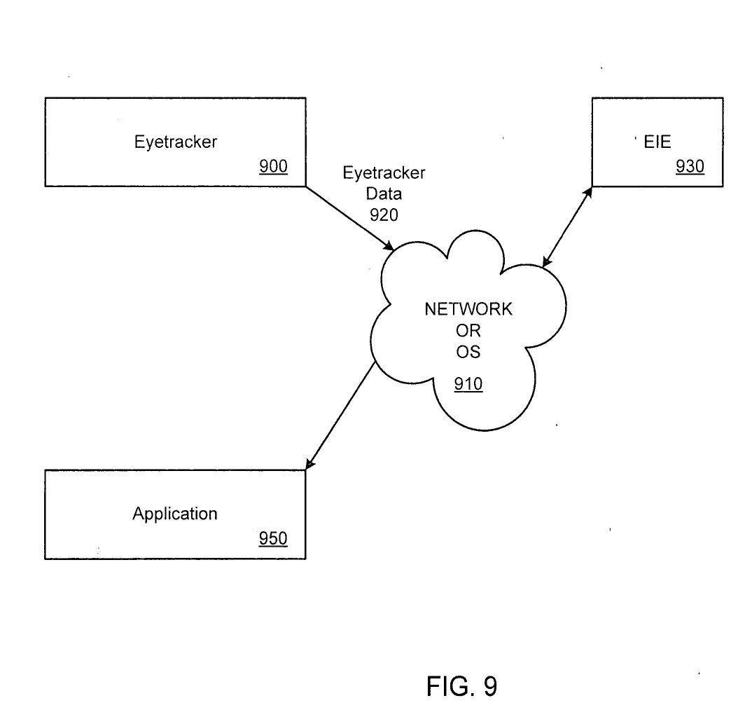

FIG. 9 is a block diagram of a first embodiment of a distributed architecture for supporting eye interpretation functionality. In one embodiment, eyetracker 900 may be coupled with eye interpretation engine 930 by network 910, which can be any type of network (e.g., a wide area network, a local area network, a personal area network). Eye interpretation engine 930 may communicate with application 950 also using network 910. This allows eyetracker 900, eye interpretation engine 930 and application 950 to be located in one or more physical locations and may be supported by one or more electronic or optical systems. In an alternate embodiment, the communication functionality provided by network 910 can be provided by one or more operating systems running on one or more corresponding electronic systems.

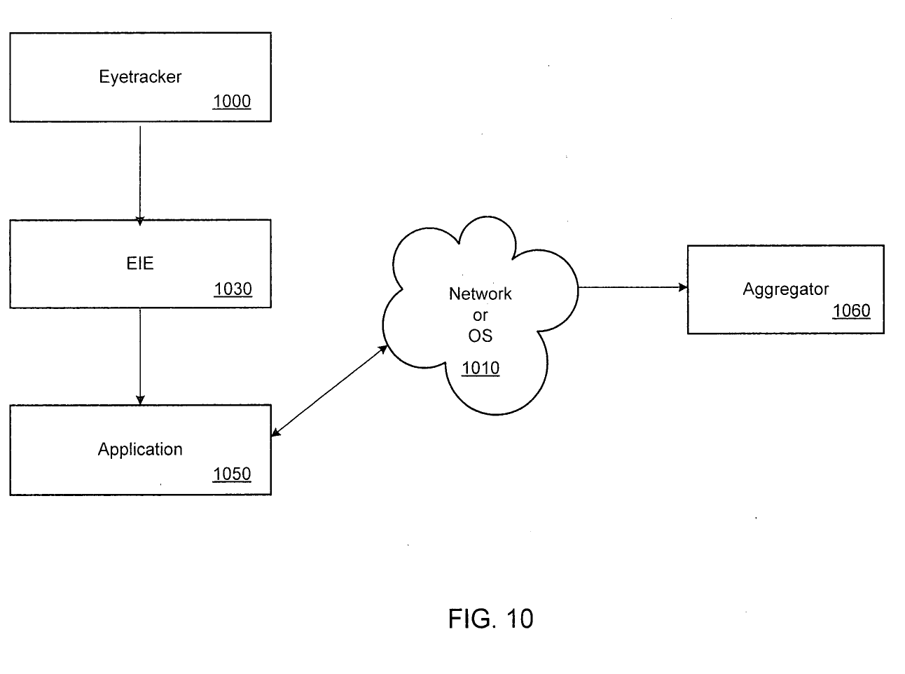

FIG. 10 is a block diagram of a second embodiment of a distributed architecture for supporting eye interpretation functionality having an aggregator. In one embodiment, eyetracker 1000 can provide eyetracking data to EIE 1030, which can communicate the eyetracking data and/or higher-level analysis to application 1050. Application 1050 may communicate eyetracking data and/or higher-level analysis to an aggregator 1060 via network 1010 (or operating system). Thus, aggregator 1060 may generate group-level analysis, statistics and/or interpretations directly or by aggregating data from one or more eye interpretation engines.

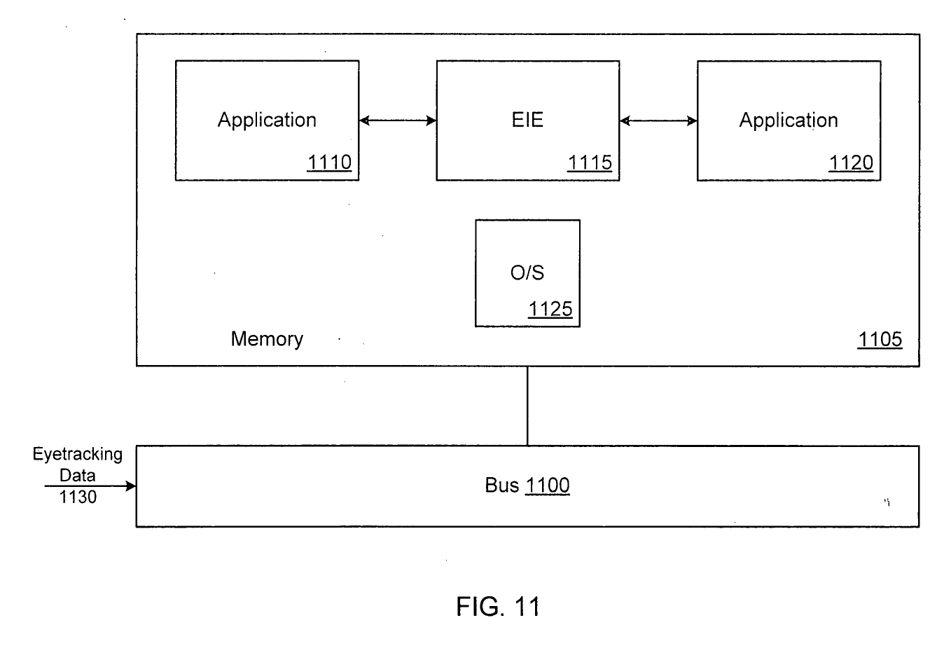

FIG. 11 is a block diagram of one embodiment of an electronic system running multiple applications sharing a single eye interpretation engine. Eyetracking data may be communicated to one or more applications stored in memory 1105 by bus 1100. Memory 1110 may store multiple applications to be executed (e.g., 1110 and 1120) as well as an operating system 1125. Applications 1110 and 1120 may communicate with eye interpretation engine 1115 that is also stored in memory 1105 for execution. Eye interpretation engine 1115 may provide eyetracking data and/or higher-level analysis to applications 1110 and 1120.

Reference in the specification to “one embodiment” or “an embodiment” means that a particular feature, structure, or characteristic described in connection with the embodiment is included in at least one embodiment of the invention. Use of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A server comprising:
a link with a source of viewing data, the source of viewing data to record viewing data that is related to activities performed by an individual, the server to receive the recorded viewing data;
a memory for storing data, the data including the recorded viewing data related to the activities performed by the individual; and
a processor to process viewing data.

2. The server of claim 1, further comprising a link with a plurality of clients, including a first client and a second client, wherein a first set of viewing data provided to the first client and a second set of viewing data provided to the second client are derived from the individual.

3. The server of claim 2, wherein the first data owner is only authorized to access the first set of viewing data and the second data owner is only authorized to access the second set of viewing data.

4. The server of claim 1, wherein the server comprises a plurality of separate computer units.

5. The server of claim 1, wherein the viewing data comprises eyetracking data.

6. The server of claim 1, wherein the memory further includes a plurality of analysis modules, and wherein the processing of the data by the processor includes the execution of an analysis module.

7. The server of claim 1, wherein the server provides instructions to the data source regarding activities to be conducted by the individual for the collection of viewing data.

8. The server of claim 1, wherein the source of the viewing data does not have access to the processing of the viewing data.

9. The server of claim 8, wherein the server does not record viewing data.

10. An eyetracking data system comprising:
a data recorder, the data recorder to record eyetracking data relating to activities performed by an individual; and
a data server, the data server to receive the eyetracking data from the data recorder, the data server to process the eyetracking data.

11. The system of claim 10, wherein a first client and a second client are to receive eyetracking data from the data server, the eyetracking data for the first client and the eyetracking data for the second client both including eyetracking data recorded from the individual.

12. The system of claim 10, wherein the data recorder and the data server operate independently of each other.

13. The system of claim 12, wherein the data recorder and the data server operate in separate physical locations.

14. The server of claim 10, wherein the server comprises a plurality of separate computer units.

15. The system of claim 10, wherein the data server provides instructions for the activities performed by the individual.

16. The system of claim 15, wherein the activities performed by the individual include viewing of a computer display.

17. The system of claim 16, wherein the viewing of the computer display includes the viewing of one or more web pages.

18. The system of claim 15, wherein the activities performed by the individual include observation of real world activities.

19. The system of claim 10, wherein the data recorder is to record viewing data for one or more activities and provide the recorded data to the data server at the conclusion of the one or more activities.

20. The system of claim 10, wherein the data recorder streams the viewing data to the data server as the data is recorded.

21. A method comprising:
providing instructions for activities to be performed by an individual;
receiving viewing data that is recorded by a data recorder, the viewing data being related to the activities performed by the individual; and
processing the received viewing data.

22. The method of claim 21, further comprising matching the individual to a first demographic requirement for a first client and a second demographic requirement for a second client, and wherein the instructions comprise a first instruction for the first client and a second instruction for the second client.

23. The method of claim 22, further comprising providing a first portion of the viewing data resulting from the first instruction to the first client and providing a second portion of the viewing data resulting from the second instruction to the second client.

24. The method of claim 21, further comprising generating the instructions automatically.

25. The method of claim 21, wherein processing the received viewing data includes analyzing the viewing data.

26. The method of claim 23, wherein analyzing the viewing data includes executing an analysis module.

27. An article comprising a computer-readable medium having stored thereon instructions that, when executed, cause one or more processors to perform operations comprising:
providing instructions to a data source for activities to be performed by an individual;
receiving eyetracking data from the data source, the eyetracking data being related to the performance of the activities by the individual; and
processing the received eyetracking data.

28. The article of claim 27, further comprising instructions for:
matching the individual to a first demographic requirement for a first client and a second demographic requirement for a second client, wherein the instructions comprise a first instruction for the first client and a second instruction for the second client.

29. The article of claim 27, further comprising instructions for:
providing a first portion of the viewing data resulting from the first instruction to the first client; and
providing a second portion of the viewing data resulting from the second instruction to the second client.
